(19) United States
(12) Patent Application Publication
(10) Pub. No.: US 2007/0026212 A1
(43) Pub. Date: Feb. 1, 2007

(54) Laminated structure with a filled viscoelastic layer and method

(75) Inventors: Ahid Nashif, Cincinnati, OH (US); Eric Denys, Ann Arbor, MI (US)

Correspondence Address: QUINN LAW GROUP, PLLC, 39555 ORCHARD HILL PLACE, SUITE # 520, NOVI, MI, 48375, US

(73) Assignee: Material Sciences Corporation

(21) Appl. No.: 11/194,175

(22) Filed: Aug. 1, 2005

(51) Int. Cl. B32B 15/04; B32B 27/20

(52) U.S. Cl. 428/220; 428/323; 428/325; 428/328; 428/324; 428/329; 428/331; 428/313.9; 428/457

(57) ABSTRACT

The present invention provides a panel providing improved noise and vibration attenuation. The panel is formed from a constrained layer viscoelastic laminate material having at least two constraining layers and at least one viscoelastic layer therebetween spanning the entirety of the constraining layers. Included within the viscoelastic layer is an effective amount of filler material operable to increase the static stiffness of the panel. A method of increasing the static stiffness of constrained layer viscoelastic materials is also provided.

### TECHNICAL FIELD

The present invention relates to a laminated structure for sound and vibration reduction with a viscoelastic layer disposed between constraining layers, wherein the laminated structure has an increased static stiffness due to the presence of fillers within the viscoelastic layer.

### BACKGROUND OF THE INVENTION

Laminated panels comprising a viscoelastic layer disposed between constraining layers have been used to attenuate noise and vibration in a number of different environments, especially to diminish the propagation of structural noise and the transmission of airborne noise.

U.S. Pat. No. 6,202,462, to Hansen et al., issued Mar. 20, 2001 to the assignee of the present invention, and hereby incorporated by reference in its entirety, describes a method of making a vibration damping constrained layer viscoelastic laminate.

Auto manufacturers have recently refocused efforts to reduce the noise of their vehicles both within the passenger cabin as well as externally. Because of these efforts, many treatments have been devised for the various panels of the vehicle. Traditional means for quieting automobiles would include mastics, doubler panels, spray-on deadener, fiberglass matting, etc. Each of these systems has its shortcomings.

Mastics are asphaltic patches which are attached to metal surfaces and hardened during a heat-elevated painting process. Heat activated mastics are also used for damping resonances. Disadvantages of mastics include: build variations between vehicles due to manual placement; airborne paint contamination resulting in paint quality issues; labor required for installation; inconsistent melt characteristics; non recyclability; susceptibility to damage during installation; interior packaging limitations due to thickness of mastics; providing only localized damping; and assembly line space requirements.

Doubler panels include a stamped panel which is welded to a body structure panel. An expandable material, such as an asphaltic type, is sandwiched between the stamping and body structure components. The sandwiched material expands and hardens when processed through the vehicle paint shop. Disadvantages of this configuration include the additional tooling required to manufacture the doubler, the welding operation required for attachment, interior packaging limitations due to thickness of the doubler, and localized damping only in the area of the doubler panel.

Spray-on deadeners are sprayed treatments which are applied via a robot to the underbody structure sheet metal components on a vehicle. Spray-on deadeners provide a noise control barrier. Disadvantages of spray-on deadeners include: masking requirement for spray applications; non-recyclability; process limited by overspray and dripping; robot requirement for application; paint shop contamination; labor and assembly line space requirement; on-going maintenance of robots; and only localized damping coverage.

Fiberglass matting provides fiberglass parts which are formed to the contour of the body component and attached during a vehicle assembly. These acoustic treatments are often used to reduce high frequency air-borne vehicle noise. Disadvantages of fiberglass matting include labor and assembly space requirements; fastener requirements; interior packaging limitations due to thickness; and the added expense and weight of the fiberglass parts.

Because of the limitations of the above mentioned treatments, automotive designers and engineers have begun to use constrained layer viscoelastic laminate materials in the production body panels. However, these panels tend to be thicker than their respective solid metal designs due to the inclusion of the viscoelastic layer and the desire to maintain the stiffness of the panel. This additional thickness may add weight, albeit less weight than the above mentioned treatments, as well as decrease the valuable packaging space in modern vehicles.

### DISCLOSURE OF THE INVENTION

The present invention provides a constrained layer viscoelastic laminate material suitable for vehicular body panels that meets the strength, noise and vibration, and packaging requirements of modern vehicles.

A constrained layer viscoelastic laminate material is provided having a laminated sheet structure with at least two constraining layers and at least one viscoelastic layer therebetween. The viscoelastic layer spans substantially the entirety of the at least two constraining layers and has a percentage by volume of particulate filler material interspersed uniformly throughout the at least one viscoelastic layer. Preferably, the percentage by volume of the particulate filler material is up to seventy five percent. The particulate filler material has a particle size of between seventy microns and the thickness of the viscoelastic layer.

The particulate filler material may include at least one of hollow spherical glass bubbles, solid spherical glass bubbles, carbon black, graphite, clay, metal particles, glass fibers, mineral fibers, mica, alumina, glass fibers, carbon fibers, and silica. The at least two constraining layers may be electro-galvanized steel or may be of different materials and thicknesses. The laminated sheet structure may be up to 0.08 inches in thickness.

A method of increasing the static stiffness of a panel formed from a constrained layer viscoelastic laminate material having at least one viscoelastic layer disposed between at least two constraining layers is provided. The method includes adding an effective amount of particulate filler material uniformly dispersed throughout the at least one viscoelastic layer of the constrained layer viscoelastic laminate in a predetermined percentage by volume so as to result in a panel with approximately the same stiffness and thickness value as a solid panel formed from the same material as one of the at least two constraining layers.

The particulate filler material may include at least one of hollow spherical glass bubbles, solid spherical glass bubbles, carbon black, graphite, clay, metal particles, glass fibers, mineral fibers, mica, alumina, glass fibers, carbon fibers, and silica. The at least two constraining layers may be steel. The constrained layer viscoelastic laminate material may be up to 0.08 inches in thickness. The predetermined percentage by volume is preferably up to seventy five percent. Additionally, the particle size of the particulate fill material is between seventy microns and the thickness of the at least one viscoelastic layer.

Also provided is a constrained layer viscoelastic laminate material having a laminated sheet structure, with a thickness of up to 0.08 inches. The laminated sheet structure has at least two steel constraining layers and at least one viscoelastic layer therebetween spanning substantially the entirety of the at least two steel constraining layers. The at least one viscoelastic layer having a percentage by volume of particulate filler material interspersed uniformly throughout the at least one viscoelastic layer. The percentage by volume of the particulate filler material is up to seventy five percent and the particulate filler material has a particle size of between seventy microns and the thickness of the viscoelastic layer. The at least two steel constraining layers may have an electro-galvanized coating.

The above features and other features and advantages of the present invention are readily apparent from the following description of the best mode for carrying out the invention when taken in connection with the accompanying drawings.

### BRIEF DESCRIPTION OF THE DRAWINGS

FIG. 1 is a schematic cross sectional view of a laminated sheet structure of the present invention comprising a “filled” viscoelastic layer disposed between two constraining layers;

FIG. 2 illustrates in graphical form the shear modulus as a function of temperature for a typical viscoelastic material, both filled and unfilled; and

FIG. 3 illustrates in graphical form the frequency response of three constrained layer viscoelastic laminate materials.

### DETAILED DESCRIPTION OF THE PREFERRED EMBODIMENT

The present invention provides a constrained layer viscoelastic laminate material suitable for vehicular body panels that meets the strength, noise and vibration, and packaging requirements of modern vehicles.

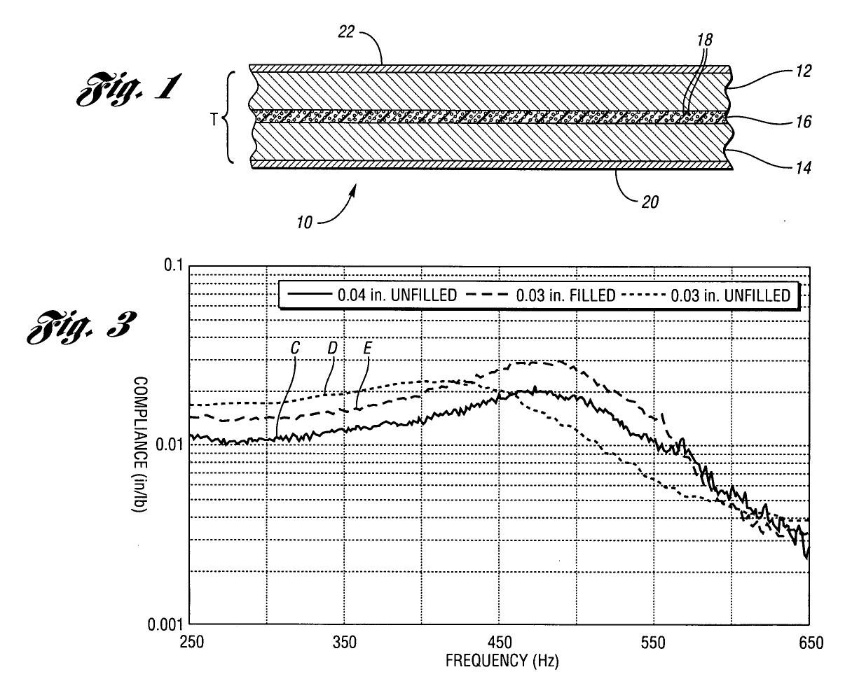

Specifically, the laminate of the present invention is formed from a laminated sheet structure (a.k.a. constrained layer viscoelastic material) 10 of thickness T, as illustrated schematically in FIG. 1. The laminated sheet structure 10 includes first and second constraining layers 12 and 14 having an engineered viscoelastic layer 16 therebetween spanning substantially the entirety of both constraining layers 12 and 14. The constraining layers 12 and 14 may be formed from any material with the necessary stiffness to provide support to the viscoelastic layer 16, such as plastics, aluminum, magnesium, titanium, and steel. In the preferred embodiment the material for the constraining layers 12 and 14 is steel. The constraining layers 12 and 14 may be the same thickness and material, however, they need not be. In the preferred embodiment, an electro-galvanized coating 20 and 22 is provided on both of the steel constraining layers 12 and 14 for corrosion resistance.

The viscoelastic layer 16 is a viscoelastic material that incorporates a volume fraction of a filler material 18. The filler material 18 may be hollow spherical glass bubbles, solid spherical glass bubbles, carbon black, graphite, clay, metal particles, glass fibers, mineral fibers, mica, alumina, carbon fibers, silica etc. However, those skilled in the art will realize that there are other types of fillers that may be used while still falling within the scope of the present invention.

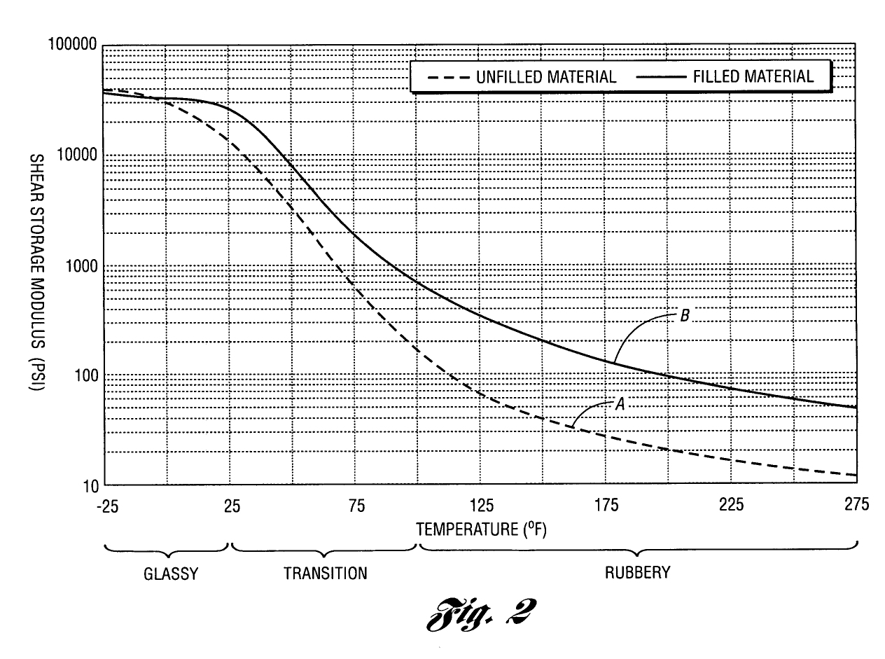

FIG. 2 illustrates the change in shear modulus as a function of temperature for both a filled and unfilled acrylic viscoelastic material at 1,000 Hz. Here, 50% by volume of the viscoelastic material was replaced by glass micro spheres. Line A represents the response of the unfilled acrylic viscoelastic material, and line B represents the response of the filled acrylic viscoelastic material. The shear moduli of both the filled and unfilled viscoelastic material are relatively the same in the glassy region, with a large difference in shear modulus in the rubbery region. The addition of fillers to the viscoelastic laminate will minimize the available free volume and, therefore, fillers have the greatest effect on the modulus of the material in the rubbery region. Conversely, fillers will have little or no effect on the modulus in the glassy region. The modulus in the transition region is affected only slightly. This is an advantageous result since the transition region is the range within which the viscoelastic material has the greatest damping efficiency. Therefore, the damping ability of the constrained layer viscoelastic laminate material 10 will be only slightly affected by the inclusion of fillers 18 in the viscoelastic layer 16. However, the stiffness of the constrained layer viscoelastic laminate material 10 will be greatly improved in the rubbery region by the inclusion of fillers 18 in the viscoelastic layer 16.

By introducing an effective amount of filler material into the viscoelastic layer 16 of the constrained layer viscoelastic laminate material 10, the thickness, T, may be approximately equal to, or slightly thicker, than that of a solid panel. FIG. 3 demonstrates graphically the effect of fillers 18 and material thickness T on the static stiffness of the constrained layer viscoelastic laminate 10. Each line represents a different sample and all three samples were of a constrained layer viscoelastic laminate 10 with the constraining layers 12 and 14 formed from steel. Line C represents a typical panel with an unfilled viscoelastic layer with a total thickness of 0.04 in. This thickness was chosen to place the static stiffness of the laminate approximately equal to that of a solid steel with a thickness of 0.03 in. Line D represents a 0.03 in. thick laminate with an unfilled viscoelastic layer, and line E represents this invention as a 0.03 in. thick laminate with a filled viscoelastic layer. Each specimen was simply supported as a cantilevered beam. A force was then applied to the free end of each beam, and the resulting displacement was recorded. By dividing the displacement by the applied force, the compliance plots for each specimen were generated and are presented in FIG. 3. The compliance of the specimens is the inverse of their stiffness. The response of the specimens below the resonant frequency ˜400 Hz provides a good comparison of the static stiffness for the three specimens. As was expected, by using an unfilled 0.03 in. thick laminate, instead of the traditional unfilled 0.04 in. thick laminate, a drop in static stiffness will result. This phenomenon is illustrated by the increase in compliance from line C to line D. As line E indicates, much of the stiffness lost due to a reduction in thickness was maintained by the addition of fillers 18 in the viscoelastic layer 16.

By utilizing the above referenced constrained layer viscoelastic laminate material 10, significant improvements in noise and vibration reduction in panels may be achieved. The addition of fillers 18 to the viscoelastic layer 16 will result in a constrained layer viscoelastic laminate 10, with improved static stiffness properties, that closely approximates the thickness of a solid panel while providing significant weight and space savings over the traditional thicker unfilled laminate panel.

The type and amount of filler material must be determined for each application. Generally, utilizing higher volume fractions of fillers 18 within the viscoelastic layer 16 will result in greater static stiffness of the constrained layer viscoelastic laminate 10. The present invention provides a percentage by volume of fillers 18 of up to seventy five percent. Additionally, the particle size of the filler 18 will not exceed the thickness of the viscoelastic layer 16 and may be as small as 70 microns. A micron is generally accepted as one thousandth of a millimeter.

While the best mode for carrying out the invention has been described in detail, those familiar with the art to which this invention relates will recognize various alternatives designs and embodiments for parts in the invention or from the scope of the appended claims.

1. A constrained layer viscoelastic laminate material comprising:
a laminated sheet structure having at least two constraining layers and at least one viscoelastic layer therebetween spanning substantially the entirety of said at least two constraining layers, said at least one viscoelastic layer having a percentage by volume of particulate filler material interspersed uniformly throughout said at least one viscoelastic layer;
wherein said percentage by volume of said particulate filler material is up to seventy five percent; and
wherein said particulate filler material has a particle size of between 10 seventy microns and the thickness of said viscoelastic layer.

2. The constrained layer viscoelastic laminate material of claim 1, wherein said percentage by volume of said particulate filler material is between twenty five and seventy five percent.

3. The constrained layer viscoelastic laminate material of claim 1, wherein said particulate filler material includes at least one of hollow spherical glass bubbles, solid spherical glass bubbles, carbon black, graphite, clay, metal particles, glass fibers, mineral fibers, mica, alumina, carbon fibers, and silica.

4. The constrained layer viscoelastic laminate material of claim 1, wherein said at least two constraining layers are steel.

5. The constrained layer viscoelastic laminate material of claim 4, wherein said at least two constraining layers have an electro-galvanized coating.

6. The constrained layer viscoelastic laminate material of claim 4, wherein said laminated sheet structure is up to 0.08 inches in thickness.

7. The constrained layer viscoelastic laminate material of claim 1, wherein each of said at least two constraining layers is a different material.

8. The constrained layer viscoelastic laminate material of claim 1, wherein each of said at least two constraining layers is a different thickness.

9. A method of increasing the static stiffness of a panel formed from a constrained layer viscoelastic laminate material having at least one viscoelastic layer disposed between at least two constraining layers comprising:
adding an effective amount of particulate filler material uniformly dispersed throughout the at least one viscoelastic layer of the constrained layer viscoelastic laminate in a predetermined percentage by volume so as to result in a panel with approximately the same stiffness and thickness value as a solid panel formed from the same material as one of the at least two constraining layers.

10. The method of claim 9, wherein said particulate filler material includes at least one of hollow spherical glass bubbles, solid spherical glass bubbles, carbon black, graphite, clay, metal particles, glass fibers, mineral fibers, mica, alumina, carbon fibers, and silica.

11. The method of claim 9, wherein the at least two constraining layers are steel.

12. The method of claim 9, wherein the constrained layer viscoelastic laminate material is up to 0.08 inches in thickness.

13. The method of claim 9, wherein said predetermined percentage by volume is up to seventy five percent.

14. The method of claim 9, wherein said predetermined percentage by volume is between twenty five and seventy five percent.

15. The method of claim 9, wherein the particle size of said particulate fill material is between seventy microns and the thickness of the at least one viscoelastic layer.

16. A constrained layer viscoelastic laminate material comprising:
a laminated sheet structure, with a thickness of up to 0.08 inches, having at least two steel constraining layers and at least one viscoelastic layer therebetween spanning substantially the entirety of said at least two steel constraining layers, said at least one viscoelastic layer having a percentage by volume of particulate filler material interspersed uniformly throughout said at least one viscoelastic layer;
wherein said percentage by volume of said particulate filler material is up to seventy five percent; and
wherein said particulate filler material has a particle size of between seventy microns and the thickness of said viscoelastic layer.

17. The constrained layer viscoelastic laminate material of claim 16, wherein said percentage by volume of said particulate filler material is between twenty five and seventy five percent.

18. The constrained layer viscoelastic laminate material of claim 16, wherein said at least two steel constraining layers have an electro-galvanized coating.
